(19) United States
(12) Patent Application Publication
(10) Pub. No.: US 2009/0220209 A1
(43) Pub. Date: Sep. 3, 2009

(54) Reproduction Apparatus and Reproduction Method

(75) Inventor: Takahisa Mori, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/470,341

(22) Filed: May 21, 2009

Related U.S. Application Data
(63) Continuation of application No. PCT/JP2008/064678, filed on Aug. 12, 2008.

(30) Foreign Application Priority Data
Sep. 28, 2007 (JP) 2007-255741

(51) Int. Cl. H04N 5/91

(52) U.S. Cl. 386/83; 386/E05.001

(57) ABSTRACT

According to one embodiment, a reproduction apparatus comprises a determination module configured to determine whether a content stored in storage has been reproduced or not, a scheduling module configured to creates a reproduction schedule of a content which is determined as not having been reproduced, a reading module configured to read the content determined as not having been reproduced from the storage in accordance with the reproduction schedule, a channel selection module configured to select a channel, and a reproduction module configured to reproduce the content which the reading module is reading when the channel selection module selects a first channel.

### CROSS REFERENCE TO RELATED APPLICATIONS

This is a Continuation Application of PCT Application No. PCT/JP2008/064678, filed Aug. 12, 2008, which was published under PCT Article 21(2) in Japanese.

This application is based upon and claims the benefit of priority from prior Japanese Patent Application No. 2007-255741, filed Sep. 28, 2007, the entire contents of which are incorporated herein by reference.

### BACKGROUND

1. Field

One embodiment of the present invention relates to a reproduction apparatus and a reproduction method.

2. Description of the Related Art

Jpn. PCT National Publication No. 2004-533745 discloses a virtual personal TV channel technique. According to the technique, a personal channel is set in accordance with a user, and content information corresponding to the user is continuously reproduced as if the information is provided from a conventional TV or radio channel.

According to the foregoing technique, programs stored in a storage device can be used as a resource of a virtual personal channel.

However, in a broadcasting receiver which includes a storage device such as a hard disk drive (HDD), the storage capacity of the storage device may be short when much broadcast contents are stored in the storage device. Therefore, the contents stored in the storage device should be properly managed.

According to the foregoing virtual personal TV channel, stored content is automatically reproduced in accordance with the user. However, the storage capacity of the storage device is not managed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing schematically an appearance of a digital television broadcast receiver to which the present invention is applied and illustrating an example of a network system in which the digital television broadcast receiver is configured as a main apparatus;

FIG. 2 is an exemplary view showing a main signal processing system of the digital television broadcast receiver;

FIG. 3 is an exemplary flowchart of favorite channel reproducing processing according to a first embodiment;

FIG. 4 is an exemplary view showing an example of reproduction schedule of favorite channel; and

FIG. 5 is an exemplary flowchart of favorite channel reproducing processing according to a second embodiment.

### DETAILED DESCRIPTION

Various embodiments according to the invention will be described hereinafter with reference to the accompanying drawings. In general, according to one embodiment of the invention, a reproduction apparatus comprises a determination module configured to determine whether a content stored in storage has been reproduced or not; a scheduling module configured to creates a reproduction schedule of a content which is determined as not having been reproduced by the determination module; a reading module configured to read the content determined as not having been reproduced from the storage in accordance with the reproduction schedule; a channel selection module configured to select a channel; and a reproduction module configured to reproduce the content which the reading module is reading when the channel selection module selects a first channel.

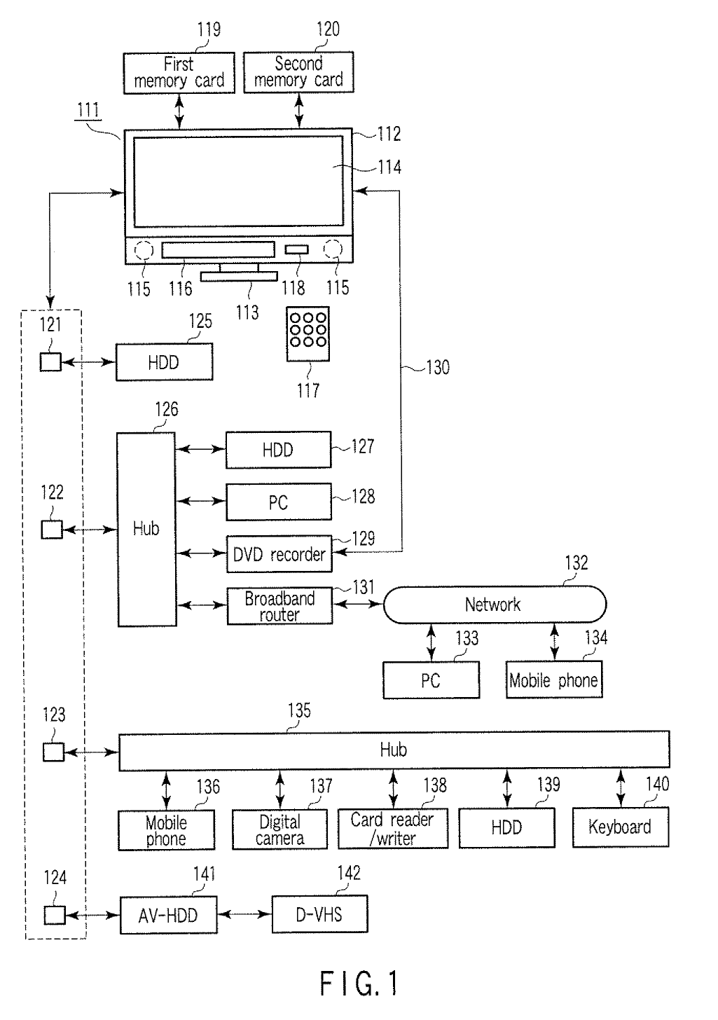

FIG. 1 is a view showing schematically an appearance of a digital television broadcast receiver 111 to which the present invention is applied and illustrating an example of a network system in which the digital television broadcast receiver 111 is configured as a main apparatus.

Specifically, the digital television broadcast receiver 111 mainly includes a thin cabinet 112 and a support base 113 which supports the cabinet 112 standing. The cabinet 112 is provided with a thin panel video display 114 including, for example, a surface-conduction electron-emission display (SED) panel or a liquid crystal display panel, a speaker 115, an operation unit 116 and an optical receiver 118. The optical receiver 118 receives control information sent from a remote controller 117.

The operation unit 116 is provided with a channel up/down key for channel selection. The remote controller 117 is also provided with a direct channel selection key and a channel up/down key for channel selection.

A first memory card 119 can be attached to and detached from the digital television broadcast receiver 111. The first memory card 119 includes, for example, a Secure Digital (SD) memory card, a Multimedia Card (MMC) or a Memory Stick. The first memory card 119 can store information such as programs and images, and the stored information may be reproduced.

Further, a second memory card 120 (IC card), which stores contract information for example, can be attached to and detached from the digital television broadcast receiver 111. It is possible to store information in the second memory card 120 and to reproduce information stored in the second memory card 120.

The digital television broadcast receiver 111 includes a first local area network (LAN) terminal 121, a second LAN terminal 122, a Universal Serial Bus (USB) terminal 123 and an i.LINK terminal 124.

The first LAN terminal 121 is used as a port dedicated to a LAN-compatible HDD. A LAN-compatible HDD 125 can be connected to the first LAN terminal 121 as a network attached storage (NAS). The first LAN terminal 121 is used to store information in the HDD 125 and to reproduce information stored in the HDD 125 by means of the Ethernet (registered trademark).

The first LAN terminal 121 is provided as the port dedicated to the LAN-compatible HDD; therefore, storing information of a program into the HDD 125 in high definition quality is available without being affected by network environment and network utilization condition.

The second LAN terminal 122 is used as a general LAN-compatible port using the Ethernet (registered trademark). The second LAN terminal 122 is connected via a hub 126 to devices such as a LAN-compatible HDD 127, a content server 128 and a Digital Versatile Disk (DVD) recorder 129 having a built-in HDD. The second LAN terminal 122 is used for information transmission with such devices.

The content server 128 has a function of operating as a server apparatus of contents in home networking. Further, the content server 128 is configured as an apparatus which is compatible to Universal Plug and Play (UPnP) offering services of providing uniform resource identifier (URI) information required for accessing a content.

Regarding the DVD recorder 129, digital information communicated via the second LAN terminal 122 is only information of a control system; therefore, it is required to provide an exclusive analog transmission line 130 for transmitting analog video and audio information with the digital television broadcast receiver 111.

The second LAN terminal 122 makes a connection with a network 132 such as the Internet through a broad band rooter 131 which is connected to the hub 126, and is utilized for information transmission with a content server 133 and a mobile phone 134 via the network 132.

The content server 133 has a function of operating as a server apparatus of contents, and is configured as an apparatus which is compatible to the UPnP offering services of providing URI information required to access a content.

The USB terminal 123 is used as a general USB-compatible port. The USB terminal 123 is connected via a hub 135, for example, with USB apparatuses such as a mobile phone 136, a digital camera 137, a card reader/writer 138 for a memory card, an HDD 139 and a keyboard 140. The USB terminal 123 is used for making information transmission with the USB apparatuses.

The i.LINK terminal 124 is used for serial-connection with an AV-HDD 141 and a Digital Video Home System (D-VHS) 142, for example, and used for making information transmission with such apparatuses.

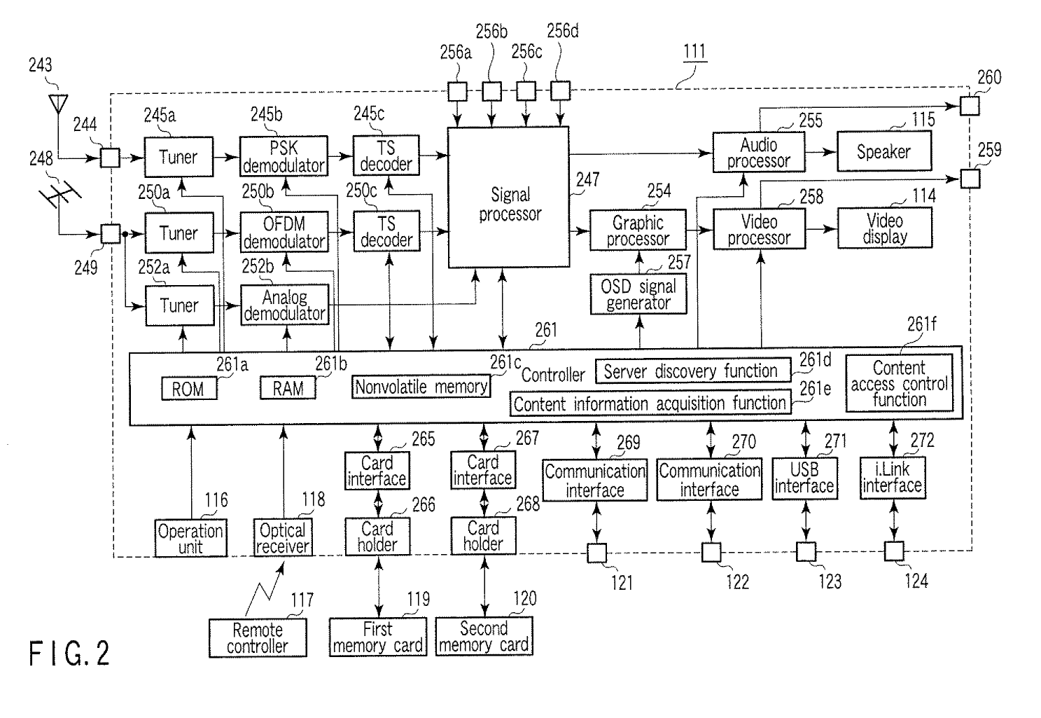

FIG. 2 is a view showing a main signal processing system of the digital television broadcast receiver 111.

An antenna 243 for broadcasting satellite (BS) and commercial satellite (CS) digital broadcasting receives a satellite digital television broadcasting signal and the received signal is supplied via an input terminal 244 to a tuner 245a for satellite digital broadcasting.

The tuner 245a selects a broadcasting signal of a desired channel in accordance with a control signal from a controller 261, and outputs the selected broadcasting signal to a phase-shift keying (PSK) demodulator 245b.

The PSK demodulator 245b demodulates the broadcasting signal selected by the tuner 245a in accordance with the control signal from the controller 261, obtains a transport stream (TS) including a desired program, and outputs the TS to a TS decoder 245c.

The TS decoder 245c performs TS-decoding on a transport-stream-multiplexed signal in accordance with a control signal from the controller 261. The TS decoder 245c de-packets digital video and audio signals of the desired program to obtain a packetized elementary stream (PES), and then, outputs the PES to a signal processor 247.

Further, the TS decoder 245c outputs section information sent by digital broadcasting to the signal processor 247.

An antenna 248 for terrestrial broadcasting receives a terrestrial digital television broadcasting signal and the received signal is supplied via an input terminal 249 to a tuner 250a for terrestrial digital broadcasting.

The tuner 250a selects a broadcasting signal of a desired channel in accordance with a control signal from the controller 261, and outputs the selected broadcasting signal to an orthogonal frequency division multiplexing (OFDM) demodulator 250b.

The OFDM demodulator 250b demodulates the broadcasting signal selected by the tuner 250a in accordance with the control signal from the controller 261, obtains a transport stream including a desired program, and outputs the transport stream to a TS decoder 250c.

The TS decoder 250c performs TS-decoding on a transport-stream-multiplexed signal in accordance with a control signal from the controller 261. Then, the TS decoder 250c outputs a packetized elementary stream (PES) obtained by de-packing digital video and audio signals of the desired program to the signal processor 247.

Further, the TS decoder 250c outputs section information sent by digital broadcasting to the signal processor 247.

To view and listen to a television program, the signal processor 247 selectively performs predetermined digital signal processing on the digital video and audio signals supplied from the TS decoders 245c and 250c, and outputs the digital video and audio signals to a graphic processor 254 and an audio processor 255, respectively. When reproducing a content, the signal processor 247 selects a content reproduction signal input from the controller 261, performs predetermined digital signal processing, and outputs the processed signal to the graphic processor 254 and the audio processor 255.

To the controller 261, various data for acquiring a program, electronic program guide (EPG) information, program attribute information (e.g., genre of program) and caption information (service information, e.g., SI and PSI) are input from the signal processor 247.

The controller 261 performs image generation for displaying the electronic program guide (EPG) and the caption based on the above input information, and outputs the generated image information to the graphic processor 254.

The signal processor 247 outputs various data for acquiring a program, electronic program guide (EPG) information, program attribute information (e.g., genre of program) and caption information (service information, e.g., SI and PSI) to the controller 261 based on the section information input from the TS decoder 245c (250c).

The graphic processor 254 has a function of synthesizing (1) digital video signal supplied from the signal processor 247, (2) on-screen display (OSD) signal generated by an OSD signal generator 257, (3) image data from data broadcasting and (4) EPG and caption signal generated by the controller 261, and a function of outputting the synthesized signal to a video processor 258.

When displaying the caption corresponding to caption broadcasting, the graphic processor 254 overlaps caption information in compliance with the control of the controller 261 on a video signal.

The digital video signal output from the graphic processor 254 is supplied to the video processor 258. The video processor 258 converts the input digital video signal to an analog video signal having a format displayable by the video display 114. Thereafter, the video processor 258 outputs the analog video signal to the video display 114 to be displayed, and outputs the analog video signal outside via an output terminal 259.

The audio processor 255 converts the input digital audio signal to an analog audio signal having a format reproducible by the speaker 115. Thereafter, the audio processor 255 outputs the analog audio signal to the speaker 115 to be reproduced, and outputs the analog audio signal outside via an output terminal 260.

The controller 261 collectively controls the entire operations in the digital television broadcast receiver 111 including the foregoing various receiving operations. The controller 261 includes a central processing unit (CPU) and others therein. The controller 261 receives operation information from the operation unit 116 or receives operation information sent from the remote controller 117 via the optical receiver 118, and controls respective portions in accordance with the operation.

The controller 261 mainly uses a read-only memory (ROM) 261a, a random access memory (RAM) 261b and a nonvolatile memory 261c. The ROM 261a stores control programs to be executed by the CPU. The RAM 261b provides a work area to the CPU. The nonvolatile memory 261c stores various setting information and control information.

The controller 261 is connected via a card interface 265 to a card holder 266 to which the first memory card 119 can be attached. Thus, the controller 261 makes information transmission via the card interface 265 with the first memory card 119 attached to the card holder 266.

Further, the controller 261 is connected via a card interface 267 to a card holder 268 to which the second memory card 120 can be attached. Thus, the controller 261 makes information transmission via the card interface 267 with the second memory card 120 attached to the card holder 268.

The controller 261 is connected to the first LAN terminal 121 via a communication interface 269. Thus, the controller 261 can make information transmission via the communication interface 269 with the LAN-compatible HDD 125 connected to the first LAN terminal 121. In this case, the controller 261 has a Dynamic Host Configuration Protocol (DHCP) server function, and allocates an Internet Protocol (IP) address to the LAN-compatible HDD 125 connected to the first LAN terminal 121 in order to control the HDD 125.

Further, the controller 261 is connected to the second LAN terminal 122 via a communication interface 270. Thus, the controller 261 can make information transmission via the communication interface 270 with various devices (see FIG. 1) connected to the second LAN terminal 122.

The controller 261 is connected to the USB terminal 123 via a USB interface 271. Thus, the controller 261 can make information transmission via the USB interface 271 with various devices (see FIG. 1) connected to the USB terminal 123.

Further, the controller 261 is connected to the i.LINK terminal 124 via an i.LINK interface 272. Thus, the controller 261 can make information transmission via the i.LINK interface 272 with various devices (see FIG. 1) connected to the i.LINK terminal 124.

According to the present embodiment, the HDD 125 stores a registration file in which a storage IDs (including IP addresses and names of devices) allocated at the time of initial registration to the HDD 125, HDD 127, content server 128 and DVD recorder 129 are described.

The nonvolatile memory 261c stores storage IDs of the HDD 125, HDD 127, content server 128 and DVD recorder 129.

The controller 261 has functions related to the present invention using UPnP, that is, (1) server discovery function 261d, (2) content information acquisition function 261e using UPnP, and (3) content access control function 261f.

(1) The controller 261 utilizes the server discovery function 261d to detect an UPnP-compatible device on a network by means of a discovery function of the UPnP. For example, the server discovery function 261d detects the content server 128 using the discovery function of the UPnP.

(2) The controller 261 utilizes the content information acquisition function 261e to control the UPnP-compatible device by means of a control function of the UPnP and acquires URI information required to access a content which is in the UPnP-compatible device. For example, the content information acquisition function 261e controls the content server 128, and from the content server 128, acquires URI information which is required to access a content stored in the HDD in the content server 128.

(3) The controller 261 utilizes the content access control function 261f to determine whether or not accessing the content is possible based on IP address information acquired by the server discovery function 261d, IP address information obtained from the URI information acquired by the content information acquisition function 261e, IP address allocated to the LAN terminal 122 of the digital television broadcast receiver 111, and netmask. When it is determined that accessing is possible, the controller 261 permits accessing the content. Conversely, when it is determined that accessing is not possible, the controller 261 causes the video display 114 to display the fact utilizing the OSD.

Subsequently, processing of reproducing “favorite channel” according to the present embodiment will be described below.

When a user operates the operation unit 116 or the remote controller 117 to give an instruction to store a received broadcast program (broadcast content), the controller 261 stores data of the broadcast program in the HDD 125.

When much broadcast programs are stored in the HDD 125, the storage capacity of the HDD 125 may be short. Therefore, proper management of contents stored in the HDD 125 is desired. Generally, an attribute indicating whether deletion of the content is permitted or inhibited is affixed to header information of a content stored in the HDD 125. The controller 261 manages data of broadcast programs stored in the HDD 125 with reference to the deletion permission attribute or the deletion inhibition attribute. The controller 261 can delete a content which is allowed to delete from the HDD 125 as required.

According to the present embodiment, when the user merely selects the “favorite channel”, an unviewed content is automatically reproduced. In addition, after the user views the unviewed content by selecting the “favorite channel”, the deletion permission attribute is automatically given to the viewed content. Thus, regarding the content which the user has already viewed, it becomes possible that the controller 261 deletes the data of the content from the HDD 125 if necessary, and thereby, shortage of the storage capacity of the HDD 125 can be prevented from occurring.

Next, the “favorite channel” in the present embodiment will be described.

Usually, the user selects a broadcast channel by operating the channel up/down key of the operation unit 116 or the channel up/down key or direct channel selection key of the remote controller 117. In the present embodiment, “favorite channel” is also selectable in addition to broadcast channels by operating the keys. When the user selects the favorite channel, not a broadcast content received by antenna 243 or 248 but an unviewed content stored in the HDD 125 is reproduced as though it is a broadcast content being currently on the air.

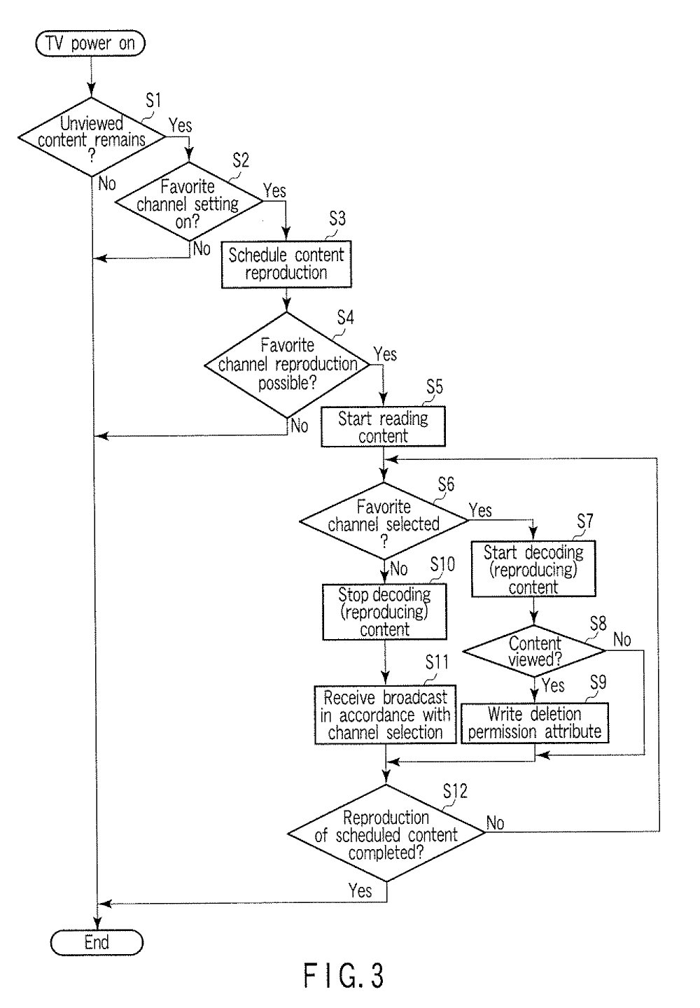

FIG. 3 is a flowchart of favorite channel reproducing processing according to the present embodiment.

When the power of the digital television broadcast receiver 111 turns on, the favorite channel reproducing processing is started. When the favorite channel reproducing processing is started, the controller 261 of the digital television broadcast receiver 111 determines whether or not a content which has not been viewed remains in the HDD 125 (block S1).

When an unviewed content is not stored in the HDD 125 (NO in block S1), the favorite channel reproducing processing is terminated. Then, ordinary reception of a broadcast content will be executed.

Conversely, when it is determined that an unviewed content remains in the HDD 125 (YES in block S1), the controller 261 determines whether or not setting of favorite channel reproduction is on (block S2). The user can set in advance whether or not to execute the favorite channel reproduction by operating the operation unit 116 or the remote controller 117.

When the setting of favorite channel reproduction is not on (NO in block S2), the favorite channel reproducing processing is terminated. Then, ordinary reception of a broadcast content will be executed.

Conversely, when the setting of favorite channel reproduction is on (YES in block S2), the controller 261 executes scheduling of contents to be reproduced in the favorite channel and creates a reproduction schedule of the favorite channel (block S3).

The scheduling is, for example, carried out in the following manner.

The scheduling is executed so that the unviewed content will be reproduced in the same time zone as a time zone in which the content has been stored (broadcast time zone of the content). For example, in the case where a news program broadcast from 19:00 has been stored and still not viewed, it is scheduled so that the news program will be reproduced from 19:00 in the favorite channel. In the case where a plurality of contents recorded in the same time zone remains not viewed, scheduling is made so that the contents will be reproduced in order of date and time of storage. Alternatively, in the case where the user previously has given priorities to genres of broadcast contents including “news,” “drama,” “sports,” and so on, the reproduction order of contents stored in the same time zone may be determined corresponding to the priorities. In the case where history of broadcast contents which the user has viewed is stored, scheduling may be executed in such a manner that reproduction will be started from a content of a genre which the user has viewed most.

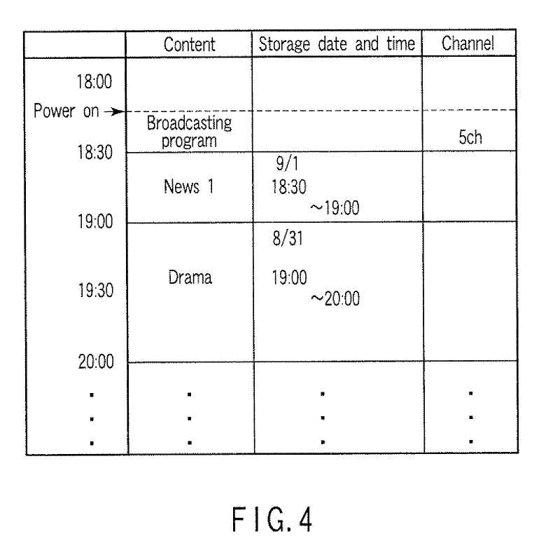

FIG. 4 is a view showing an example of the reproduction schedule of the favorite channel obtained from the processing of block S3.

For a time zone in which no corresponding unviewed content is present, such setting can be made in advance that a broadcast content which will be broadcast in the time zone is inserted to the reproduction schedule. In FIG. 4, an empty time having no corresponding unviewed content continues from power activation of the digital television broadcast receiver 111 until 18:30. An ordinary broadcast content is inserted into the empty time.

The reproduction schedule of the favorite channel may be created so that all unviewed contents are included therein. Alternatively, a schedule merely for predetermined time period (e.g., six hours) may be created. The created reproduction schedule of the favorite channel is stored in the ROM 261a.

After scheduling, the controller 261 determines whether or not the favorite channel reproduction is possible (block S4). As a result of the scheduling processing in block S3, when the schedule is not filled enough, it is determined that the favorite channel reproduction is not possible. For example, when there is no unviewed content and the user previously sets the schedule so that viewing an ordinary broadcast content is not to be inserted to the empty time, the reproduction schedule of the favorite channel is not filled enough. Therefore, it is determined that the favorite channel reproduction is not possible (NO in block S4).

When it is determined that the favorite channel reproduction is not possible (NO in block S4), the favorite channel reproducing processing is terminated, and then, ordinary reception of a broadcast content will be executed.

Conversely, when it is determined that the favorite channel reproduction is possible (YES in block S4), the controller 261 starts reading content data from the HDD 125 based on the created reproduction schedule of the favorite channel (block S5). Thereafter, the controller 261 continues reading a content from the HDD 125 based on the created reproduction schedule of the favorite channel. If not reading a content stored in the HDD 125 but receiving a broadcast content which is on the air is scheduled, the broadcast content may be received based on the schedule; however, receiving the broadcast content may be started when the favorite channel is selected.

When the user selects the favorite channel by operating the channel up/down key of the operation unit 116 or the channel up/down key or the direct channel selection key of the remote controller 117 (YES in block S6), reproduction (decoding) of content data read from the HDD 125 is started (block S7). That is, the video processor 258 and the audio processor 255 execute predetermined decoding processing on the content data read from the HDD 125 under the control of the controller 261. The video processor 258 and the audio processor 255 output the decoded content data to the video display 114 and the speaker 115.

Therefore, when the user merely selects the favorite channel in the same manner as normal channel selection, a content which has been stored but not viewed can be reproduced and viewed. In the case where not reading data from the HDD 125 but receiving a broadcast content is being executed based on the reproduction schedule of the favorite channel, the video processor 258 and the audio processor 255 execute predetermined decoding processing on the broadcast content being received under the control of the controller 261. Then, the video processor 258 and the audio processor 255 output the broadcast content to the video display 114 and the speaker 115.

The controller 261 determines whether or not a content which is being currently reproduced can be considered as already viewed content (block S8). In the case where the user has viewed the content more than a predetermined ratio (e.g., 20% of the content), the controller 261 determines that the content is already viewed. When it is determined that the content which is being currently reproduced is already viewed (YES in block S8), the controller 261 writes a deletion permission attribute to the header of the content (block S9).

The controller 261 determines whether or not reproduction of the contents scheduled based on the reproduction schedule of the favorite channel is completed (block S12). When reproduction of the contents included in the reproduction schedule is not completed (NO in block S12), content reproduction is continued based on the reproduction schedule of the favorite channel until a channel is changed in block S6.

When the user selects a channel other than the favorite channel (NO in block S6), the controller 261 stops reproducing content data read from the HDD 125 (block S10). In the case where not reading data from the HDD 125 but reproducing a broadcast content which is currently broadcast is being executed, the reproduction of the broadcast content is stopped.

Thereafter, a broadcast content corresponding to the channel selection made by the user is received and reproduced (block S11). That is, the video processor 258 and the audio processor 255 execute predetermined decoding processing on the broadcast content being currently received under the control of the controller 261. The video processor 258 and the audio processor 255 output the decoded broadcast content to the video display 114 and the speaker 115.

Subsequently, the controller 261 determines whether or not reproducing the contents scheduled based on the reproduction schedule of the favorite channel is completed (block S12). When reproduction of the contents included in the reproduction schedule of the favorite channel is not completed (NO in block S12), reception and reproduction of a broadcast content in accordance with channel selection made by the user is continued until a channel is changed in block S6.

Reading a stored content from the HDD 125 is carried out based on the reproduction schedule of the favorite channel. Thus, when the user changes the channel to the favorite channel from a channel other than the favorite channel (YES in block S6), the content reproduction in the favorite channel is started again from a point which is advanced by a time corresponding to the time for which the user has viewed another channel (block S7). That is, in the favorite channel, the stored content is reproduced as though it is a usual broadcast content.

When the reproduction of the contents included in the reproduction schedule of the favorite channel is completed as described above (YES in block S12), the favorite channel reproducing processing is terminated.

According to the present embodiment, when the power of the digital television broadcast receiver 111 turns on, scheduling of a stored but unviewed content is carried out. When the user selects the favorite channel, the unviewed content is reproduced according to the reproduction schedule of the favorite channel. Thus, the user only selects the favorite channel in the same manner as normal channel selection, and thereby, the unviewed content can be reproduced and viewed. That is, the user can view the unviewed content by similar operation to zapping and is not required to give specific instructions to view the unviewed content.

A deletion permission attribute is automatically affixed to a content which has been viewed to some extent in the favorite channel. The controller 261 deletes the content if necessary by reference to the deletion permission attribute. Therefore, shortage of the storage capacity of the HDD 125 can be prevented.

### Second Embodiment

A second embodiment of the present invention will be hereinafter described. In the second embodiment, the same reference numerals are used to designate portions corresponding to the first embodiment, and detailed descriptions are omitted. The configuration of the second embodiment is as shown in the block diagram of FIG. 2.

In the first embodiment, reading content data from the HDD 125 is always carried out during the favorite channel reproduction processing. However, if accessing the HDD 125 is continued, the HDD 125 easily becomes breakable. Reading content data from the HDD 125 may be carried out according to need. In the second embodiment, when the favorite channel is selected, a seek position is calculated to reproduce a stored content.

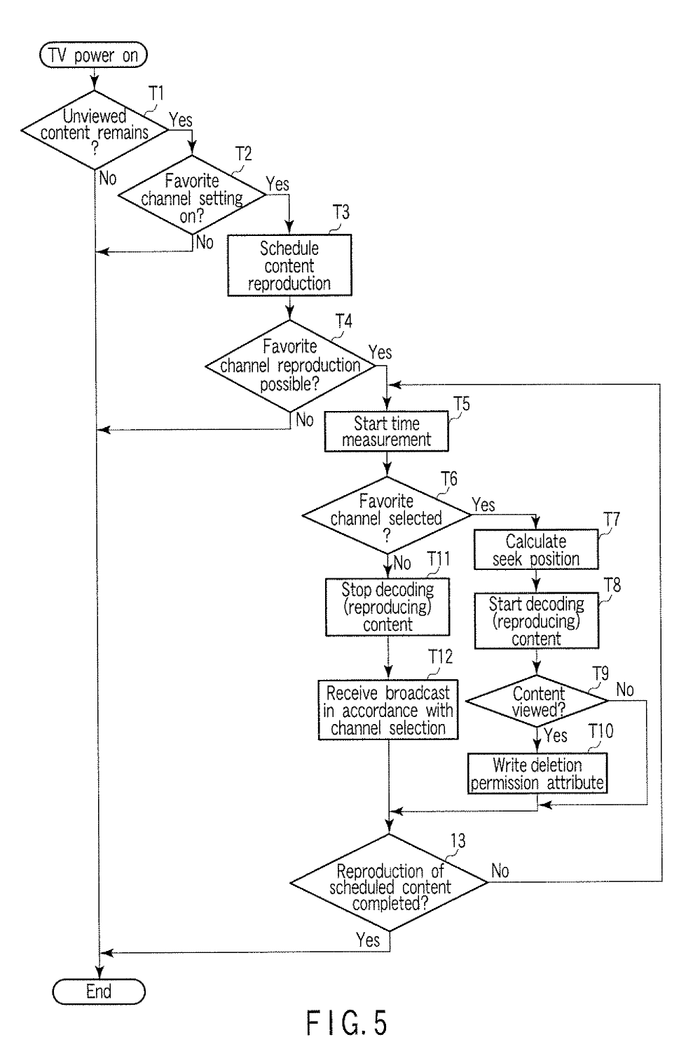

FIG. 5 is a flowchart of favorite channel reproducing processing according to the second embodiment.

When the power of the digital television broadcast receiver 111 turns on, the favorite channel reproducing processing is started. When the favorite channel reproducing processing is started, the controller 261 of the digital television broadcast receiver 111 determines whether or not a content which has not been viewed remains in the HDD 125 (block T1).

When an unviewed content is not stored in the HDD 125 (NO in block T1), the favorite channel reproducing processing is terminated. Then, ordinary reception of a broadcast content will be executed.

Conversely, when it is determined that an unviewed content remains in the HDD 125 (YES in block T1), the controller 261 determines whether or not setting of favorite channel reproduction is on (block T2).

When the setting of favorite channel reproduction is not on (NO in block T2), the favorite channel reproducing processing is terminated. Then, ordinary reception of a broadcast content will be executed.

Conversely, when the setting of favorite channel reproduction is on (YES in block T2), the controller 261 executes scheduling of contents to be reproduced in the favorite channel and creates a reproduction schedule of the favorite channel (block T3).

The scheduling is carried out in the similar manner to the first embodiment. For example, a reproduction schedule of the favorite channel shown in FIG. 4 is created. The created reproduction schedule of the favorite channel is stored in the ROM 261a.

After scheduling, the controller 261 determines whether or not the favorite channel reproduction is possible (block T4). As a result of the scheduling processing, when the schedule is not filled enough, it is determined that the favorite channel reproduction is not possible. For example, when there is no unviewed content and the user previously sets the schedule so that viewing an ordinary broadcast content is not to be inserted to the empty time, the reproduction schedule of the favorite channel is not filled enough. Therefore, it is determined that the favorite channel reproduction is not possible (NO in block T4).

When it is determined that the favorite channel reproduction is not possible (NO in block T4), the favorite channel reproducing processing is terminated, and then, ordinary reception of a broadcast content will be executed.

Conversely, when it is determined that the favorite channel reproduction is possible (YES in block T4), the controller 261 starts up a built-in timer to start time measurement (block T5).

When the user selects the favorite channel by operating the channel up/down key of the operation unit 116 or the channel up/down key or the direct channel selection key of the remote controller 117 (YES in block T6), the controller 261 calculates a seek position to start reproduction of a stored content (block T7).

That is, a position (seek position) to start reproduction (decoding processing) of the stored content, which enables reproduction in compliance with the reproduction schedule, is calculated based on the time measured by the timer and a bit rate of the stored content scheduled in the reproduction schedule.

When the seek position is calculated, content data stored in the HDD 125 is read from the calculated seek position, and reproduction of the read data is started (block T8). That is, the video processor 258 and the audio processor 255 execute predetermined decoding processing on the content data read from the calculated seek position under the control of the controller 261. The video processor 258 and the audio processor 255 output the decoded content data to the video display 114 and the speaker 115.

The controller 261 determines whether or not a content which is being currently reproduced can be considered as already viewed content (block T9). In the case where the user has viewed the content more than a predetermined ratio (e.g., 20% of the content), the controller 261 determines that the content is already viewed. When it is determined that the content which is being currently reproduced is already viewed (YES in block T9), the controller 261 writes a deletion permission attribute to the header of the content (block T10).

The controller 261 determines whether or not reproduction of the contents scheduled based on the reproduction schedule of the favorite channel is completed (block T13). When reproduction of the contents included in the reproduction schedule is not completed (NO in block T13), content reproduction is continued based on the reproduction schedule of the favorite channel until a channel is changed in block T6.

When the user selects a channel other than the favorite channel (NO in block T6), the controller 261 stops reproducing content data read from the HDD 125 (block T11). In the case where not reading data from the HDD 125 but reproducing a broadcast content which is currently on the air is being executed, the reproduction of the broadcasting content is stopped.

Thereafter, a broadcast content corresponding to the channel selection made by the user is received and reproduced (block T12). That is, the video processor 258 and the audio processor 255 execute predetermined decoding processing on the broadcast content being currently received under the control of the controller 261. The video processor 258 and the audio processor 255 output the decoded broadcast content to the video display 114 and the speaker 115.

Subsequently, the controller 261 determines whether or not reproducing the content scheduled based on the reproduction schedule of the favorite channel is completed (block T13). When reproduction of the contents included in the reproduction schedule of the favorite channel is not completed (NO in block T13), reception and reproduction of broadcast content in accordance with channel selection made by the user is continued until a channel is changed in block T6.

When the reproduction of the contents included in the reproduction schedule of the favorite channel is completed as described above (YES in block T13), the favorite channel reproducing processing is terminated.

According to the present embodiment, when the favorite channel is selected, a seek position is calculated based on the time measured by the timer and the bit rate of a stored content. Reading the stored content data is started from the calculated seek position. Thus, there is no need to continue accessing the HDD 125, and therefore, degradation of the HDD 125 can be prevented.

Reading a stored content from the HDD 125 is carried out from a seek position calculated based on the reproduction schedule of the favorite channel. When the user selects the favorite channel from a channel other than the favorite channel, the content reproduction in the favorite channel is started again from a point advanced by a time corresponding to the time for which the user has viewed another channel. That is, in the favorite channel, the stored content is reproduced as though it is a usual broadcast content.

According to the present embodiment, when the power of the digital television broadcast receiver 111 turns on, scheduling of a stored but unviewed content is carried out. When the user selects the favorite channel, the unviewed content is reproduced according to the reproduction schedule of the favorite channel. Thus, the user only selects the favorite channel in the same manner as normal channel selection, and thereby, the unviewed content can be reproduced and viewed. That is, the user can view the unviewed content by similar operation to zapping and is not required to give specific instructions to view the unviewed content.

A deletion permission attribute is automatically affixed to a content which has been viewed to some extent in the favorite channel. The controller 261 deletes the content if necessary by reference to the deletion permission attribute. Therefore, shortage of the storage capacity of the HDD 125 can be prevented.

In the foregoing first and second embodiments, when the user selects the favorite channel, a stored content can be viewed. When the selected channel changes to the favorite channel from a channel other than the favorite channel, the content is advanced by a time for which user has viewed the channel other than the favorite channel, and the content is reproduced. Thus, the user can view the stored content as though it is a usual broadcasting program. However, when the channel is changed from the favorite channel to another channel, a position at which the reproduction (decoding) is stopped in the reproduction schedule may be stored in the RAM 261b; and when the channel returns to the favorite channel again, the reproduction may be started again from the position at which the reproduction is stopped stored in the RAM 261b. That is, when a change from the favorite channel to another channel is made, a resume position is stored in the RAM 261b; and when a change to the favorite channel is made, reproduction is started from the resume position. In this way, the user can view entirely the stored content in the favorite channel.

According to the foregoing first and second embodiments, a broadcast content is stored in the HDD 125. However, the storage device is not limited to the HDD 125. For example, the present invention is applicable to the case where the broadcast content is stored in the DVD recorder 129 having a built-in HDD via the second LAN terminal 122.

In addition, the present invention is not limited to storage of broadcast content but also applicable to management of viewing a content acquired (downloaded) via a network.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. A reproduction apparatus comprising:
a determination module configured to determine whether a content stored in storage has been reproduced or not;
a scheduling module configured to creates a reproduction schedule of a content which is determined as not having been reproduced by the determination module;
a reading module configured to read the content determined as not having been reproduced from the storage in accordance with the reproduction schedule;
a channel selection module configured to select a channel; and
reproduction module configured to reproduce the content which the reading module is reading when the channel selection module selects a first channel.

2. The reproduction apparatus of claim 1, further comprising a broadcast reception module configured to receive a broadcast content, and wherein the reproduction module reproduces the broadcast content which the broadcast reception module receives.

3. The reproduction apparatus of claim 1, further comprising an attribute affixing module configured to affix a deletion permission attribute to the content reproduced by the reproduction module.

4. The reproduction apparatus of claim 1, wherein the scheduling module creates the reproduction schedule so that the content determined as not having been reproduced is reproduced in a same time band as a time band the content is stored in the storage.

5. The reproduction apparatus of claim 1, wherein the scheduling module creates the reproduction schedule so that the reproduction module reproduces the content determined as not having been reproduced in a same time band as the content is stored in the storage.

6. The reproduction apparatus of claim 1, wherein the reading module calculates reading start point at which reading the content determined as not having been reproduced from the storage is started based on the reproduction schedule.

7. The reproduction apparatus of claim 1, wherein the content stored in the storage includes audio data and image data, and the reproduction module includes an audio output module configured to output the audio data and a display module configured to display the image data.

8. A content display method comprising:
determining whether a content stored in storage has been reproduced or not;
creating a reproduction schedule of a content which is determined as not having been reproduced;
reading the content determined as not having been reproduced from the storage in accordance with the reproduction schedule;
selecting a channel; and
reproducing the content which is being read when the channel selection module selects a first channel.
